(19) United States
(12) Patent Application Publication
(10) Pub. No.: US 2026/0330849 A1
(43) Pub. Date: Oct. 22, 2026

(54) IMAGE ANALYSIS SYSTEM AND IMAGE ANALYSIS METHOD

(71) Applicant: NATIONAL CHENG KUNG UNIVERSITY, Tainan City (TW)

(72) Inventors: Pau-Choo CHUNG, Tainan City (TW); Chin Hua LIU, Tainan City (TW); Kuan Wei LIN, Tainan City (TW)

(21) Appl. No.: 19/571,638

(22) Filed: Mar. 19, 2026

(30) Foreign Application Priority Data
Apr. 18, 2025 (TW) 114114783

(51) Int. Cl. G06V 20/69; G06T 11/00; G06V 10/764; G06V 20/20

(52) U.S. Cl. CPC G06V 20/698; G06T 11/00; G06V 10/764; G06V 20/20; G06T 2200/24; G06T 2210/41; G06V 2201/031

(57) ABSTRACT

An image analysis system includes an image capture device and a computing platform. The image capture device is configured to capture a pathological image from a stream output by a microscope. The computing platform is communicatively connected to the image capture device and is configured to receive the pathological image from the image capture device. The computing platform includes a memory and a processor. The memory is configured to store the pathological image. The processor is communicatively connected to the memory and is configured to classify the pathological image utilizing a classification model to obtain a classification result, and select an analysis model from a model pool based on the classification result to analyze the pathological image to obtain an analysis result, and superimpose the analysis result on the pathological image to obtain a superimposed result, and output the superimposed result to a user interface.

### RELATED APPLICATION

This application claims priority to Taiwan Application Serial Number 114114783, filed Apr. 18, 2025, which is herein incorporated by reference.

### BACKGROUND

### Technical Field

The present disclosure relates to an image analysis system and an image analysis method, and more particularly to a pathological image analysis system and a pathological image analysis method.

### Description of Related Art

Digital pathology utilizes scanners to convert pathological slide images into digital form and stores these digital images on servers for pathologists to analyze through the network. These systems are typically equipped with image processing software for magnification, reduction, and measurement of pathological features. These digital pathological images may be processed utilizing artificial intelligence algorithms, such as cell counting, tumor boundary detection, and tissue segmentation, providing information to assist pathologists in diagnosis. Currently, conventional technologies may achieve high-definition pathological slide image streaming and provide simple image processing tools. For example, remote microscopy platforms allow users to share pathological slide images through streaming to the network for real-time pathological image presentation. However, while these conventional technologies may process pathological images, they do not yet possess the ability to perform real-time analysis utilizing machine learning models, and their reliance on high-resolution scanners presents significant challenges in terms of implementation cost.

### SUMMARY

The objective of the present disclosure is to provide an image analysis system and an image analysis method aimed at improving the efficiency and accuracy of pathological diagnosis. The image analysis system connects an image capture device to a microscope, streams pathological slide images to a computing platform equipped with a graphics processing unit (GPU), and utilizes a machine learning model to perform real-time analysis of the digital pathological images. The image analysis system and the image analysis method employ a classification model and an analysis model based on machine learning methods. The pathological image is initially classified utilizing the classification model, and then a suitable specialized analysis model is selected from a model pool based on the classification result for further analysis. This classification-then-analysis approach ensures that each type of pathological image may be processed by the best-matched analysis model. Furthermore, the analysis result output by the analysis model is automatically superimposed on the pathological image, assisting pathologists in real-time cell or tissue labeling and interpretation, thereby reducing diagnostic time. The image analysis system proposed in the present disclosure is particularly suitable for scenarios requiring rapid and accurate pathological examination, such as tumor screening and histological analysis, providing an efficient and accurate auxiliary diagnostic tool.

One aspect of the present disclosure relates to an image analysis system. The image analysis system includes an image capture device and a computing platform. The image capture device is configured to capture a pathological image from a stream output by a microscope. The computing platform is communicatively connected to the image capture device, and is configured to receive the pathological image from the image capture device. The computing platform includes a memory and a processor. The memory is configured to store the pathological image. The processor is communicatively connected to the memory, and is configured to classify the pathological image utilizing a classification model to obtain a classification result, and select an analysis model from a model pool based on the classification result to analyze the pathological image to obtain an analysis result, and superimpose the analysis result on the pathological image to obtain a superimposed result, and output the superimposed result to a user interface.

In accordance with one or more embodiments of the present disclosure, the processor utilizes the analysis model to analyze the pathological image to obtain the analysis result, and outputs the superimposed result to the user interface in real time in response to the image capture device capturing the pathological image from the stream.

In accordance with one or more embodiments of the present disclosure, the processor is further configured to store the analysis result output by the analysis model into the memory.

In accordance with one or more embodiments of the present disclosure, the model pool contains at least one machine learning model.

In accordance with one or more embodiments of the present disclosure, the classification model and the analysis model are machine learning models established utilizing machine learning methods.

Another aspect of the present disclosure relates to an image analysis method, which includes the following steps: capturing a pathological image from a stream output by a microscope through an image capture device; receiving the pathological image from the image capture device through a computing platform, and storing the pathological image in a memory of the computing platform; classifying the pathological image utilizing a classification model through a processor of the computing platform to obtain a classification result; selecting an analysis model from a model pool based on the classification result through the processor to analyze the pathological image to obtain an analysis result; and superimposing the analysis result onto the pathological image to obtain a superimposed result through the processor, and outputting the superimposed result to a user interface.

In accordance with one or more embodiments of the present disclosure, the processor utilizes the analysis model to analyze the pathological image to obtain the analysis result, and outputs the superimposed result to the user interface in real time in response to the image capture device capturing the pathological image from the stream.

In accordance with one or more embodiments of the present disclosure, the processor is further configured to store the analysis result output by the analysis model into the memory.

In accordance with one or more embodiments of the present disclosure, the model pool contains at least one machine learning model.

In accordance with one or more embodiments of the present disclosure, the classification model and the analysis model are machine learning models established utilizing machine learning methods.

### BRIEF DESCRIPTION OF THE DRAWINGS

The patent or application file contains at least one drawing executed in color. Copies of this patent or patent application publication with color drawings will be provided by Office upon request and payment of the necessary fee. The disclosure can be more fully understood by reading the following detailed description of the embodiment, with reference made to the accompanying drawings as follows.

FIG. 1 is a functional block diagram of an image analysis system in accordance with some embodiments of the present disclosure.

FIG. 2 is a schematic diagram of a liver pathological image captured by an image capture device in accordance with some embodiments of the present disclosure.

FIG. 3 is a schematic diagram of an analysis result output by an analysis model in accordance with some embodiments of the present disclosure.

FIG. 4 is a schematic diagram of a superimposed result obtained by superimposing an analysis result onto a pathological image through a processor in accordance with some embodiments of the present disclosure.

FIG. 5 is a schematic diagram of a liver pathological image captured by an image capture device in accordance with some embodiments of the present disclosure.

FIG. 6 is a schematic diagram of an analysis result output by an analysis model in accordance with some embodiments of the present disclosure.

FIG. 7 is a schematic diagram of a superimposed result obtained by superimposing an analysis result onto a pathological image through a processor in accordance with some embodiments of the present disclosure.

FIGS. 8-10 are schematic diagrams illustrating editing a superimposed result on a user interface in accordance with some embodiments of the present disclosure.

FIG. 11 is a flowchart of an image analysis method in accordance with some embodiments of the present disclosure.

### DETAILED DESCRIPTION

Embodiments of the present disclosure will be discussed in detail below. It should be understood that the embodiments provide multiple applicable concepts that may be implemented in a wide variety of specific situations. The embodiments discussed and disclosed are for illustrative purposes only and are not intended to limit the scope of the present disclosure.

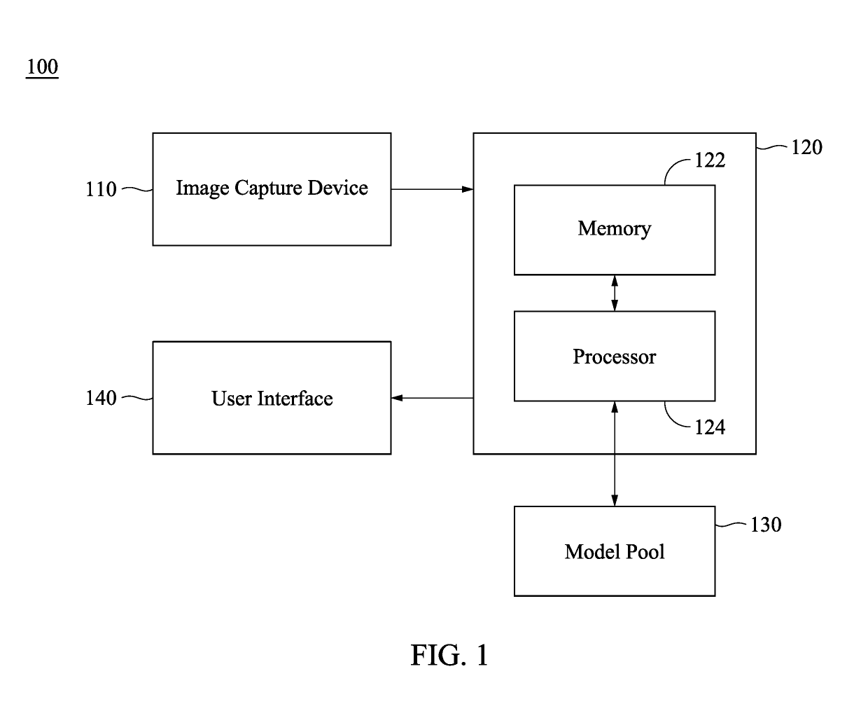

FIG. 1 is a functional block diagram of an image analysis system 100 in accordance with some embodiments of the present disclosure. The image analysis system 100 includes an image capture device 110, a computing platform 120, a model pool 130, and a user interface 140. The computing platform 120 may also include a memory 122 and a processor 124, but the present disclosure does not limit the types or number of components present in the computing platform 120. The image capture device 110 is configured to capture a pathological image from a stream output by a microscope (not shown in FIG. 1). The computing platform 120 is communicatively connected to the image capture device 110, and is configured to receive the pathological image from the image capture device 110. The computing platform 120 may also include a memory 122 and a processor 124. The memory 122 is configured to store the pathological image and may be random access memory (RAM), read-only memory (ROM), flash memory, solid-state drive (SSD), or other similar components or combinations thereof, but is not limited thereto. The processor 124 is communicatively connected to the memory 122, and is configured to classify the pathological image utilizing a classification model to obtain a classification result. Based on the classification result, the processor selects an analysis model from a model pool 130 to analyze the pathological image and obtain an analysis result. The analysis result is then superimposed onto the pathological image to obtain a superimposed result, which is output to a user interface 140. The processor 124 may be a central processing unit (CPU), graphics processing unit (GPU), microcontroller unit (MCU), microprocessor, system-on-chip (SoC), digital signal processor (DSP), application-specific integrated circuit (ASIC), programmable logic controller (PLC), or a combination of these components, but is not limited thereto.

In one embodiment of the present disclosure, pathological slides under the microscope is a continuously output stream, and the image capture device 110 in the image analysis system 100 may be installed on the microscope to capture pathological images from the slide image stream output by the microscope, that is, to obtain digital pathological images. The image capture device 110 may be a digital camera, an IP camera, a charge-coupled device (CCD) camera, a complementary metal-oxide-semiconductor (CMOS) camera, or any device capable of capturing images or pictures, but the present disclosure is not limited thereto.

After the image capture device 110 captures a pathological image, the computing platform 120 then receives the pathological image from the image capture device 110, and stores the pathological image in the memory 122 of the computing platform 120. The processor 124 in the computing platform 120 then accesses the pathological image stored in the memory 122 and utilizes a classification model to classify the pathological image to obtain a classification result. In specific, the processor 124 may utilize the classification model to determine image features of the pathological image. These image features may be organ type, sampling technique, staining type, etc. The present disclosure does not limit the image features that the classification model may distinguish.

In one embodiment of the present disclosure, the processor 124 may utilize the classification model to determine the organ type of the pathological image, that is, utilize the organ type of each pathological image as the classification basis. For example, the processor 124 may utilize the classification model to determine that the organ type of the pathological image belongs to the large intestine, liver, breast tissue, or other organ types. The present disclosure does not limit this.

In another embodiment of the present disclosure, the processor 124 may also utilize the classification model to identify the sampling technique of the pathological image, that is, utilize the sampling technique of each pathological image as the classification basis. For example, the processor 124 may utilize the classification model to identify that the sampling technique of the pathological image belongs to puncture sampling, slide sampling, or other sampling techniques. The present disclosure does not limit this.

In another embodiment of the present disclosure, the processor 124 may also utilize the classification model to determine the staining type of the pathological image, that is, utilize the staining type of each pathological image as the classification basis. For example, the processor 124 may utilize the classification model to determine that the staining type of the pathological image belongs to hematoxylin and eosin stain (H&E stain), Masson's trichrome stain, or other staining types. The present disclosure does not limit this.

After obtaining the classification result of the pathological images (e.g., the organ type, the sampling technique, the staining type, etc. identified by the classification model), the processor 124 then accesses the model pool 130 to select the most suitable analysis model from one or more machine learning models to further analyze the pathological image and obtain the analysis result of the pathological image. That is, regardless of whether the classification result of the pathological images obtained by the classification model is based on organ type, sampling technique, staining type, or other image features, the processor 124 may select the most suitable analysis model from the model pool 130 to analyze the pathological image based on the classification result. Furthermore, the processor 124 may also store the obtained analysis result of the pathological image in the memory 122 in the form of, for example, a snapshot, for future search or as a control group reference for long-term case follow-up.

After obtaining the analysis result of the pathological image, the processor 124 then superimposes the analysis result onto the pathological image to obtain the superimposed result (i.e., the analysis result superimposed on the original pathological image), and outputs the superimposed result to the user interface 140. It is worth mentioning that the technical scheme proposed in the present disclosure is a real-time application. That is, while realizing the image transmission function (i.e., presenting the pathological image captured by the image capture device 110 to the user interface 140), the processor 124 may analyze the pathological image in real time utilizing the analysis model to obtain the analysis result, and simultaneously output the superimposed result to the user interface 140. This implementation not only significantly shortens the screening time for pathologists, enabling them to complete multiple examinations in a short time and maximizing the satisfaction of pathologists' needs for real-time diagnosis, but also allows other pathologists located remotely to view the same images output by the system through network connection, satisfying the needs of remote collaboration among pathologists.

It should be noted that the classification model and analysis model utilized by the processor 124 are machine learning models established utilizing machine learning methods, and the present disclosure does not limit the machine learning methods utilized.

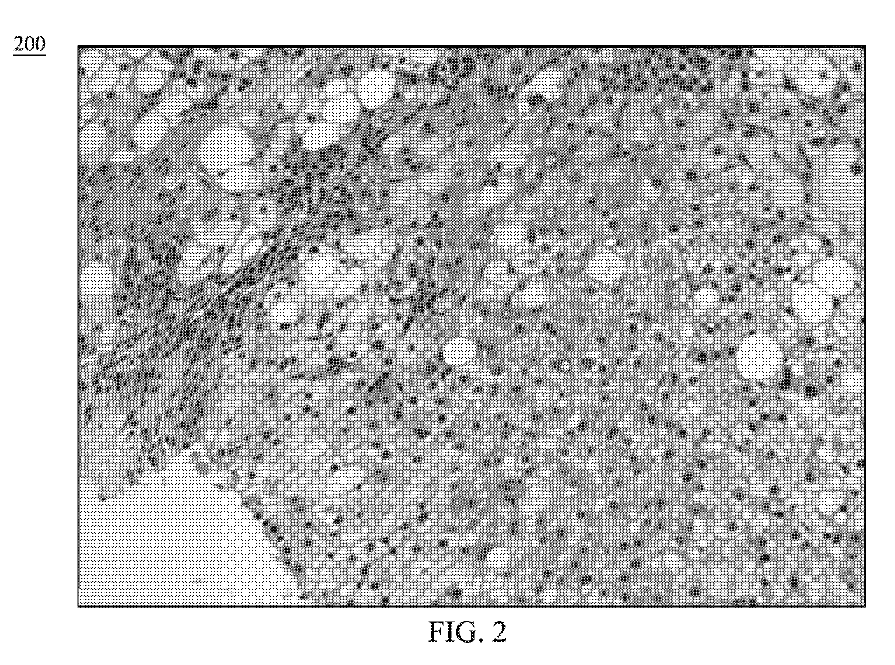

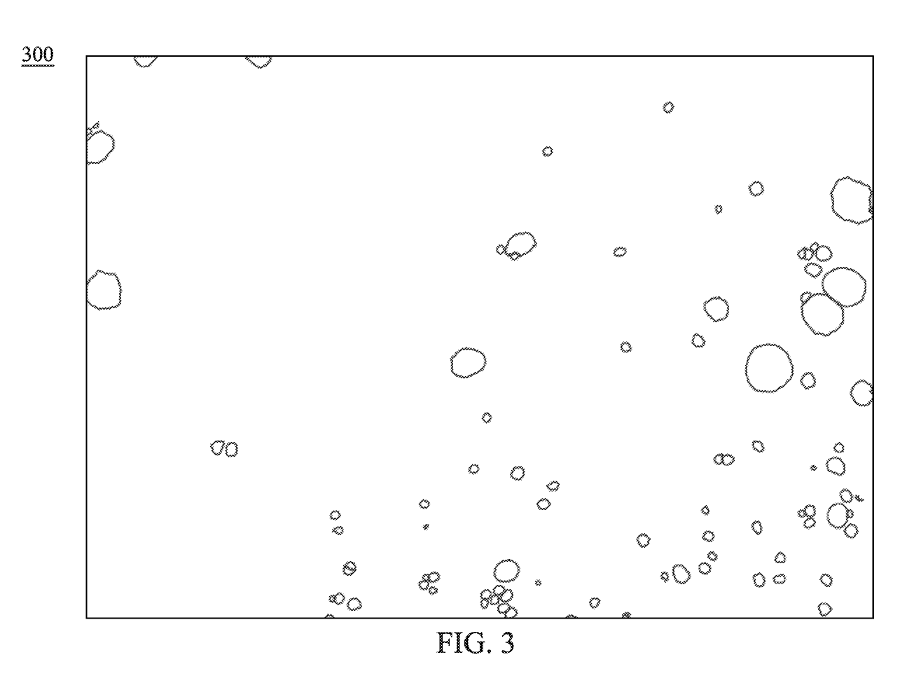

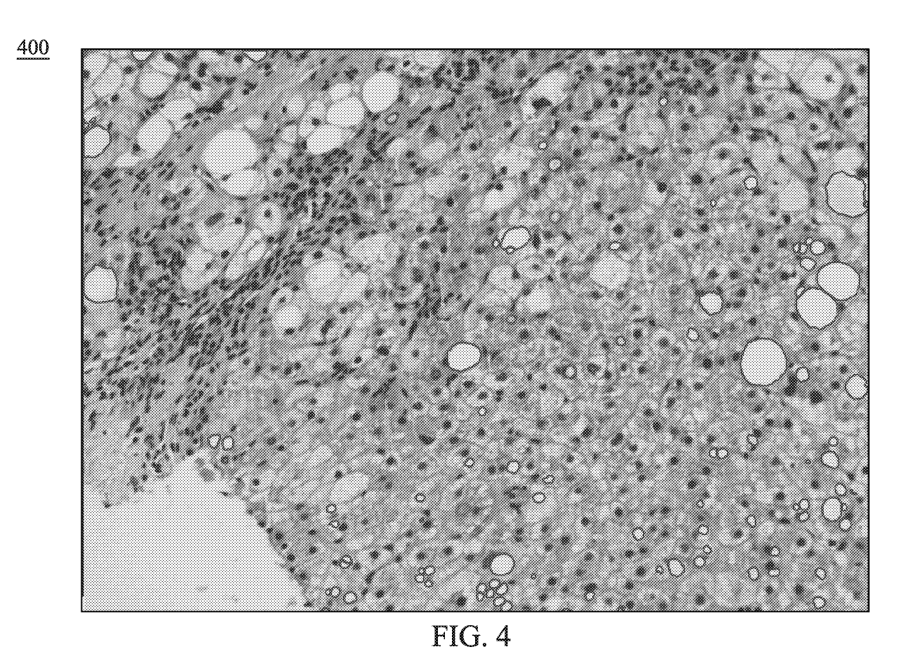

This paragraph, in conjunction with FIGS. 2-4, describes an embodiment of pathological image processing utilizing the classification model and the analysis model. FIG. 2 is a schematic diagram 200 of a liver pathological image captured by the image capture device 110. The processor 124 first accesses the liver pathological image stored in the memory 122, and then classifies the liver pathological image utilizing the classification model, so as to obtain a classification result (i.e., staining type) of hematoxylin-eosin staining. Next, the processor 124 accesses the model pool 130 to select an analysis model (i.e., a lipid droplet model) specific to the hematoxylin-eosin staining type from one or more machine learning models to further analyze the pathological image, thereby obtaining the analysis result of the pathological image, as shown in the schematic diagram 300 of the analysis result in FIG. 3. The area depicted by the lines output by the analysis model is the location of the lipid droplet (or oil droplet) area, which may be referred to as the area depicted by the blue lines in FIG. 3. Finally, the processor 124 superimposes the analysis result onto the original pathological image to obtain a superimposed result, and outputs the superimposed result in real time to the user interface 140, as shown in the schematic diagram 400 of the superimposed result in FIG. 4. The pathologist may then make an immediate diagnosis by observing the real-time output superimposed result.

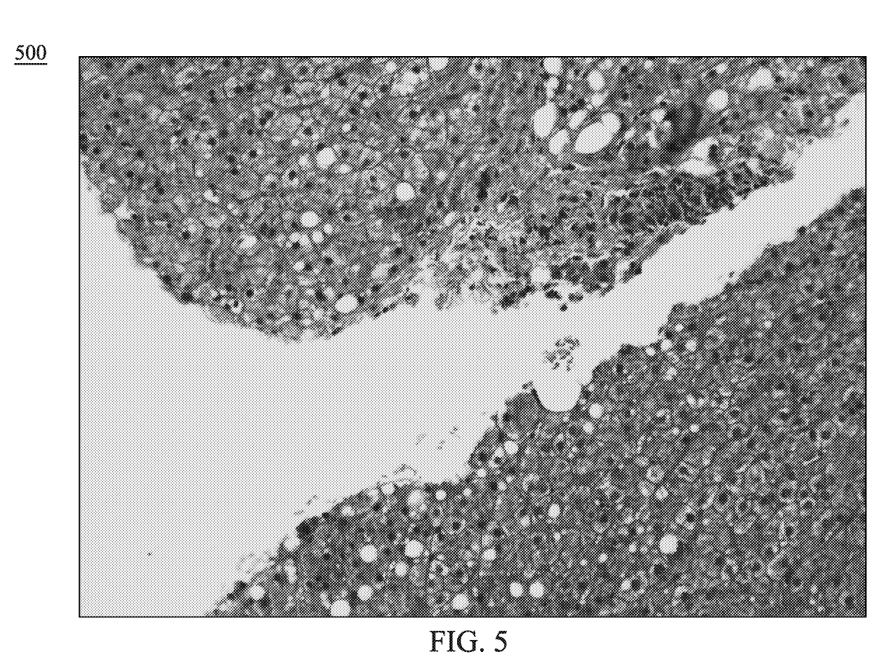

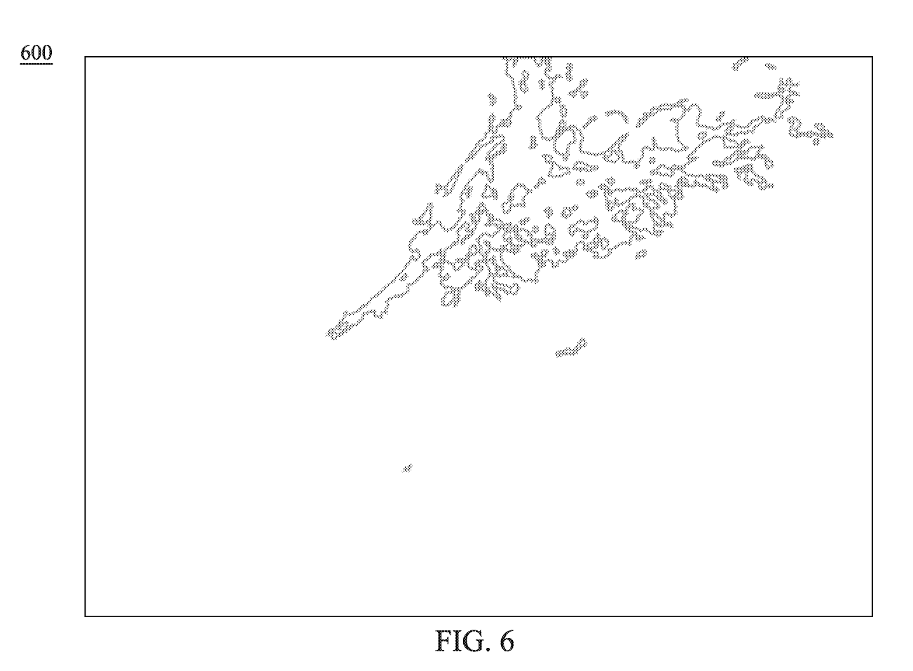

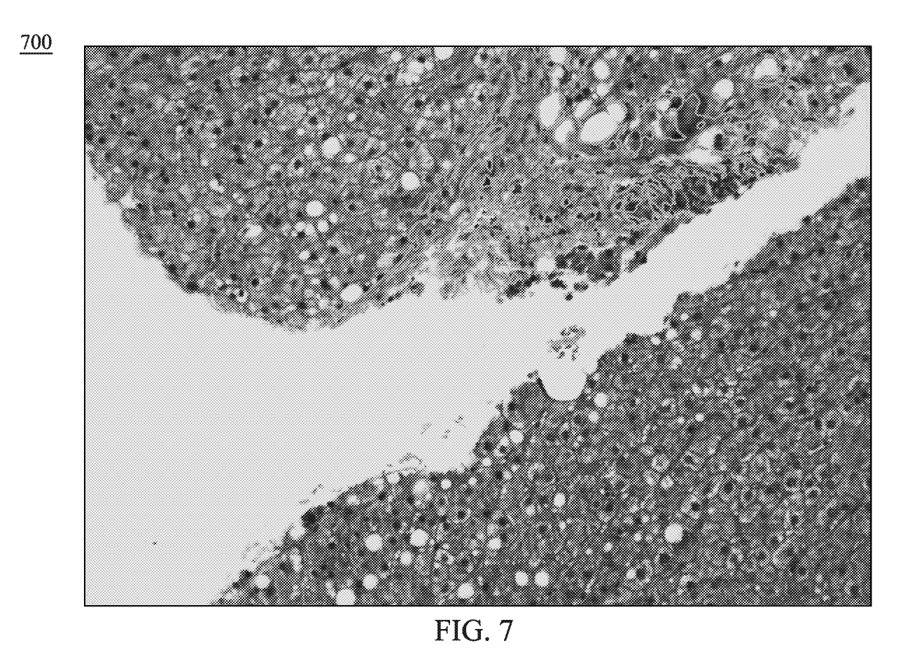

This paragraph, in conjunction with FIGS. 5-7, describes an embodiment of pathological image processing utilizing the classification model and the analysis model. FIG. 5 is a schematic diagram 500 of a liver pathological image captured by the image capture device 110. The processor 124 first accesses the liver pathological image stored in the memory 122, and then classifies the liver pathological image utilizing the classification model, so as to obtain a classification result (i.e., staining type) of Massen trichrome staining. Next, the processor 124 accesses the model pool 130 to select an analysis model (i.e., a fibrosis model) specific to the Massen trichrome staining type from one or more machine learning models to further analyze the pathological image, thereby obtaining the analysis result of the pathological image, as shown in the schematic diagram 600 of the analysis result in FIG. 6. The area depicted by the lines output by the analysis model is the location of the fibrotic area, which may be referred to as the area depicted by the green lines in FIG. 6. Finally, the processor 124 superimposes the analysis result onto the original pathological image to obtain a superimposed result, and outputs the superimposed result in real time to the user interface 140, as shown in the schematic diagram 700 of the superimposed result in FIG. 7. The pathologist may then make an immediate diagnosis by observing the real-time output superimposed result.

In other embodiments of the present disclosure, the analysis result output by the analysis model (such as the lipid droplet model, fibrosis model described in the above two embodiments, or other machine learning models applicable to other staining types) are not necessarily in the form of images, but may also be presented in the form of texts (such as outputting an analysis report) on the user interface 140. The present disclosure does not limit the form of the analysis result.

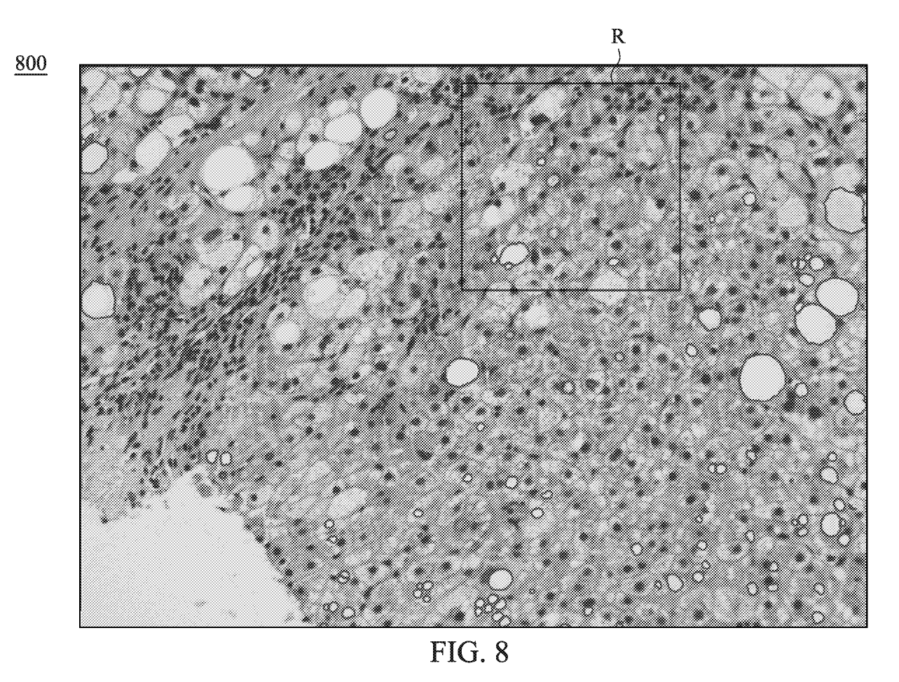

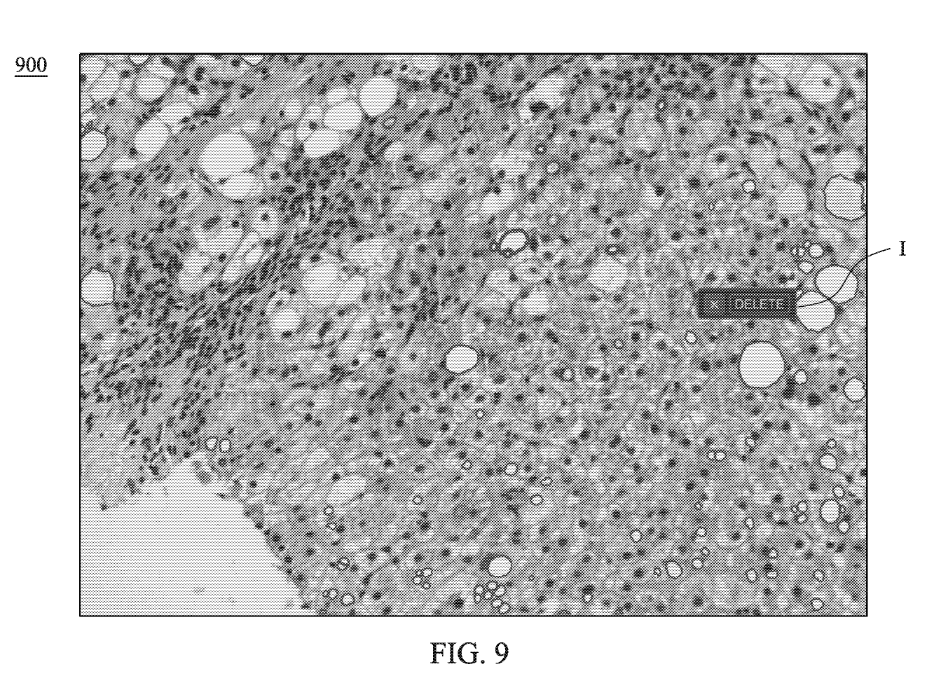

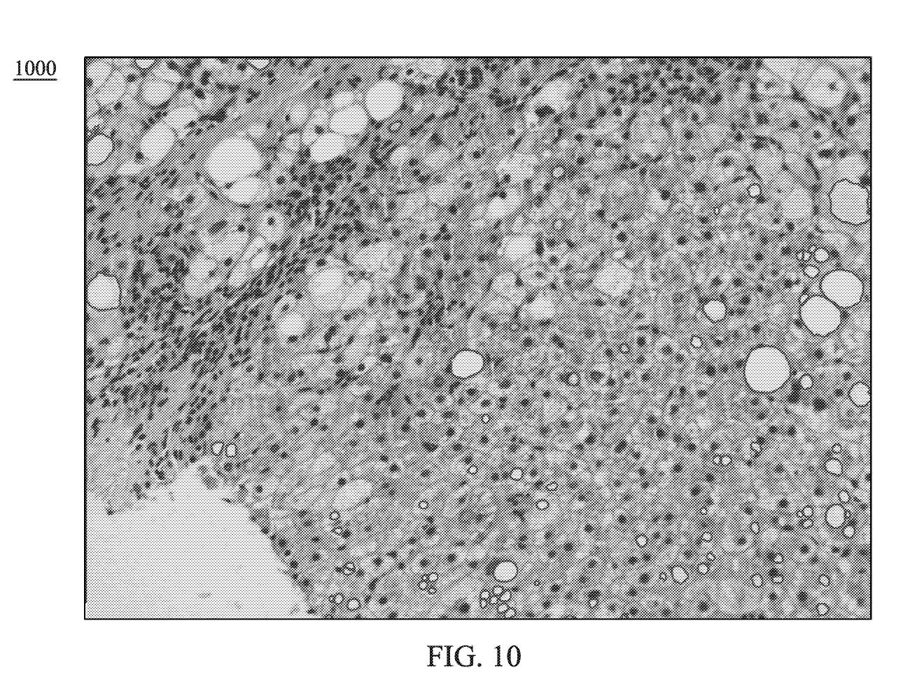

In some embodiments, the superimposed result output to the user interface 140 also has an editing function. This paragraph describes one embodiment of this editing function in conjunction with FIGS. 8-10. After the processor 124 outputs the superimposed result to the user interface 140, the operator of the image analysis system 100 may select and delete the analysis result (e.g., the blue bold line area in the schematic diagram 900 of the edited superimposed result shown in FIG. 9) of a certain area (e.g., the edited area R in the schematic diagram 800 of the edited superimposed result shown in FIG. 8) according to different application needs, thereby excluding areas in the pathological image that the operator determines no need to be observed. In detail, after the operator selects the edited area R to be deleted, the user interface 140 may display an icon corresponding to this edited area R (e.g., icon I shown in schematic diagram 900) for the operator to click to perform the "delete" editing operation. After the operator clicks icon I, the final output result may be referred to the schematic diagram 1000 of the edited superimposed result shown in FIG. 10.

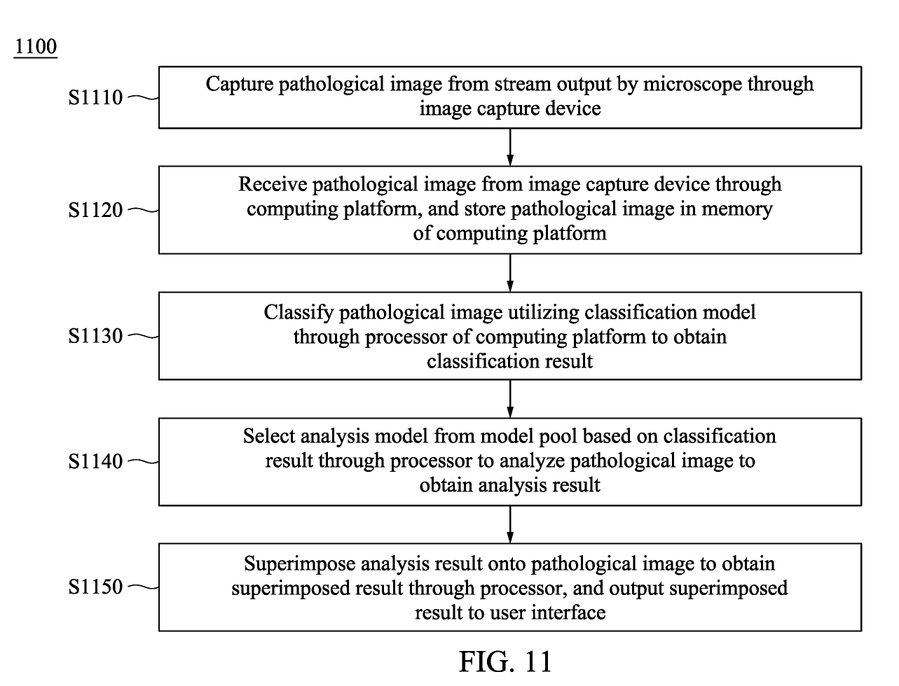

FIG. 11 is a flowchart of an image analysis method 1100 in accordance with some embodiments of the present disclosure. The image analysis method 1100 may be performed by, for example, the image analysis system 100 shown in FIG. 1, which includes the image capture device 110, the computing platform 120 (further including but not limited to the memory 122 and the processor 124), the model pool 130, and the user interface 140, or other similar systems. The image analysis method 1100 includes Steps S1110 to S1150. The following paragraphs describe the implementation of each step in the image analysis method 1100 in conjunction with the content of FIGS. 1-11.

S1110: capture a pathological image from a stream output by a microscope through an image capture device.

S1120: receive the pathological image from the image capture device through a computing platform, and store the pathological image in a memory of the computing platform.

S1130: classify the pathological image utilizing a classification model through a processor of the computing platform to obtain a classification result.

S1140: select an analysis model from a model pool based on the classification result through the processor to analyze the pathological image to obtain an analysis result.

S1150: superimpose the analysis result onto the pathological image to obtain a superimposed result through the processor, and output the superimposed result to a user interface.

The explanation of Steps S1110 to S1150 above may be found in the operation of the components in the image analysis system 100 as shown in FIG. 1, and will not be repeated herein.

As can be seen from the above description, the image analysis system and the image analysis method of the present disclosure connect an image capture device to a microscope, streams pathological slide images to a computing platform, and utilize a machine learning model to perform real-time analysis of the digital pathological images. The image analysis system and the image analysis method employ a classification model and an analysis model based on machine learning methods. The pathological image is initially classified utilizing the classification model, and then a suitable specialized analysis model is selected from a model pool based on the classification result for further analysis. This classification-then-analysis approach ensures that each type of pathological image may be processed by the best-matched analysis model. Furthermore, the analysis result output by the analysis model is automatically superimposed on the pathological image, assisting pathologists in real-time cell or tissue labeling and interpretation, thereby reducing diagnostic time. The image analysis system proposed in the present disclosure is particularly suitable for scenarios requiring rapid and accurate pathological examination, such as tumor screening and histological analysis, providing an efficient and accurate auxiliary diagnostic tool.

Although the present disclosure has been disclosed above by way of embodiments, it is not intended to limit the scope of the present disclosure. Anyone skilled in the art may make various changes, substitutions and modifications without departing from the spirit and scope of the present disclosure. Therefore, the scope of protection of the present disclosure shall be defined by the appended claims.

What is claimed is:

1. An image analysis system comprising:
an image capture device configured to capture a pathological image from a stream output by a microscope; and
a computing platform communicatively connected to the image capture device and configured to receive the pathological image from the image capture device, the computing platform comprising:
a memory configured to store the pathological image; and
a processor communicatively connected to the memory and configured to classify the pathological image utilizing a classification model to obtain a classification result, and select an analysis model from a model pool based on the classification result to analyze the pathological image to obtain an analysis result, and superimpose the analysis result on the pathological image to obtain a superimposed result, and output the superimposed result to a user interface.

2. The image analysis system of claim 1, wherein the processor utilizes the analysis model to analyze the pathological image to obtain the analysis result, and outputs the superimposed result to the user interface in real time in response to the image capture device capturing the pathological image from the stream.

3. The image analysis system of claim 1, wherein the processor is further configured to store the analysis result output by the analysis model into the memory.

4. The image analysis system of claim 1, wherein the model pool contains at least one machine learning model.

5. The image analysis system of claim 1, wherein the classification model and the analysis model are machine learning models established utilizing machine learning methods.

6. An image analysis method comprising:
capturing a pathological image from a stream output by a microscope through an image capture device;
receiving the pathological image from the image capture device through a computing platform, and storing the pathological image in a memory of the computing platform;
classifying the pathological image utilizing a classification model through a processor of the computing platform to obtain a classification result;
selecting an analysis model from a model pool based on the classification result through the processor to analyze the pathological image to obtain an analysis result; and
superimposing the analysis result onto the pathological image to obtain a superimposed result through the processor, and outputting the superimposed result to a user interface.

7. The image analysis method of claim 6, wherein the processor utilizes the analysis model to analyze the pathological image to obtain the analysis result, and outputs the superimposed result to the user interface in real time in response to the image capture device capturing the pathological image from the stream.

8. The image analysis method of claim 6, wherein the processor is further configured to store the analysis result output by the analysis model into the memory.

9. The image analysis method of claim 6, wherein the model pool contains at least one machine learning model.

10. The image analysis method of claim 6, wherein the classification model and the analysis model are machine learning models established utilizing machine learning methods.
